(19) United States
(12) Patent Application Publication
(10) Pub. No.: US 2006/0202606 A1
(43) Pub. Date: Sep. 14, 2006

(54) Inductive output tube tuning arrangement

(75) Inventors: Edward S. Sobieradzki, Essex (GB); Stuart W. Andrews, Essex (GB); Stephen W. Hurrell, Essex (GB)

Correspondence Address: VENABLE LLP, P.O. BOX 34385, WASHINGTON, DC, 20045-9998, US

(73) Assignee: E2V Technologies (UK) Limited, Essex (GB)

(21) Appl. No.: 11/356,450

(22) Filed: Feb. 17, 2006

(30) Foreign Application Priority Data
Feb. 17, 2005 (GB) 0503332.9

(51) Int. Cl. H01J 63/04

(52) U.S. Cl. 313/495

(57) ABSTRACT

An inductive output tube includes a capacitative tuner in the form of a plunger which is moveable inside the integral output cavity of the inductive output tube so as to vary the capacitance between an input and output drift tube and hence the resonant frequency of the output stage. The tuning plunger is moveable by protruding through a wall of the vacuum envelope of the output cavity, so as to allow the capacitance to be changed by operation of the tuning plunger by manual or automatic means from outside the cavity.

### CROSS-REFERENCE TO RELATED APPLICATION

This application claims the priority of British Patent Application No. 0503332.9 filed on Feb. 17, 2005, the subject matter of which is incorporated herein by reference.

### BACKGROUND OF THE INVENTION

Linear beam tube devices such as electron beam tube devices are used for the amplification of RF signals. There are various types of linear electron beam tube known to those skilled in the art, two examples of which are the klystron and the Inductive Output Tube (IOT). Linear electron beam tubes incorporate an electron gun for the generation of an electron beam of an appropriate power. The electron gun includes a cathode heated to a high temperature so that the application of an electric field between the cathode and an anode results in the emission of electrons. Typically, the anode is held at ground potential and the cathode at a large negative potential of the order of tens of kilovolts.

Electron beam tubes used as amplifiers broadly comprise three sections. An electron gun generates an electron beam, which is modulated by application of an input signal. The electron beam then passes into a second section known as the interaction region, which is surrounded by a cavity arrangement including an output cavity arrangement from which the amplified signal is extracted. The third stage is a collector, which collects the spent electron beam.

In an inductive output tube (IOT) a grid is placed close to and in front of the cathode, and the RF signal to be amplified is applied between the cathode and the grid so that the electron beam generated in the gun is density modulated. The density modulated electron beam is directed through an RF interaction region, which includes one or more resonant cavities, including an output cavity arrangement. The beam is focused by a magnetic means typically a set of electromagnetic coils to ensure that it passes through the RF region and delivers power at an output section within the interaction region where the amplified RF signal is extracted. After passing through the output section, the beam enters the collector where it is collected and the remaining power is dissipated. The amount of power which needs to be dissipated depends upon the efficiency of the linear beam tube, this being the difference between the power of the beam generated at the electron gun region and the RF power extracted in the output coupling of the RF region.

The difference between an IOT and a Klystron is that in an IOT, the RF input signal is applied between a cathode and a grid close to the front of the cathode. This causes density modulation of the electron beam. In contrast, a klystron velocity modulates an electron beam, which then enters a drift space in which electrons that have been speeded up catch up with electrons that have been slowed down. The bunches are thus formed in the drift space, rather than in the gun region itself.

We have appreciated that different applications of linear beam amplifiers provide different requirements for output frequency and power. In UHF transmitter applications, linear beam devices need to be tuned over a wide range. In contrast, in scientific applications such as synchrotrons, high power is required in a continuous wave mode. We have appreciated, though, that an Inductive Output Tube can be modified to optimise its use in such scientific applications.

### SUMMARY OF THE INVENTION

The invention is defined in the claims to which reference is now directed.

The invention resides in an Inductive Output Tube (IOT) of the type having an integral output cavity. An embodiment of the IOT includes an additional tuning element within the output cavity arranged to vary the capacitance of the output cavity and hence the frequency of operation. Such frequency tuning can be used to fine tune the IOT frequency when designed to be used in a continuous wave mode at a given frequency for applications such as scientific synchrotrons.

The use of a capacitative tuning element in an integral output cavity of an IOT allows the IOT to have a fixed output cavity geometry, rather than a tunable cavity door as embodied in external cavity systems, and consequently to meet the demanding requirements of scientific applications whilst minimising effects such as RF leakage. The IOT embodying the invention may be embodied in an electron beam tube device.

### BRIEF DESCRIPTION OF THE DRAWINGS

An embodiment of the invention in the various aspects noted above will now be described with reference to the figures in which:

FIG. 1: shows a schematic diagram of an Inductive Output Tube (IOT) fitted with external cavities;

FIG. 2: shows an integral cavity arrangement of an IOT;

FIG. 3: shows an integral cavity IOT embodying the invention;

FIG. 4: shows the integral cavity IOT of FIG. 3 with a modified seal;

FIG. 5: shows the integral cavity IOT of FIG. 4 with a modified coating;

FIG. 6: shows an alternative IOT arrangement; and

FIG. 7 shows an integral cavity IOT with a combination of the seal of FIG. 3 and the diaphragm of FIG. 4.

### DETAILED DESCRIPTION OF THE INVENTION

The embodiment of the invention is an integral output cavity Inductive Output Tube (IOT). It is important to note that the invention is applicable to such IOTs because an integral cavity IOT is capable of better performance for continuous wave applications such as scientific devices but tunability is not usually required. We appreciated, though, that some tunability for fine tuning such an IOT is useful so as to optimise a particular IOT to the application.

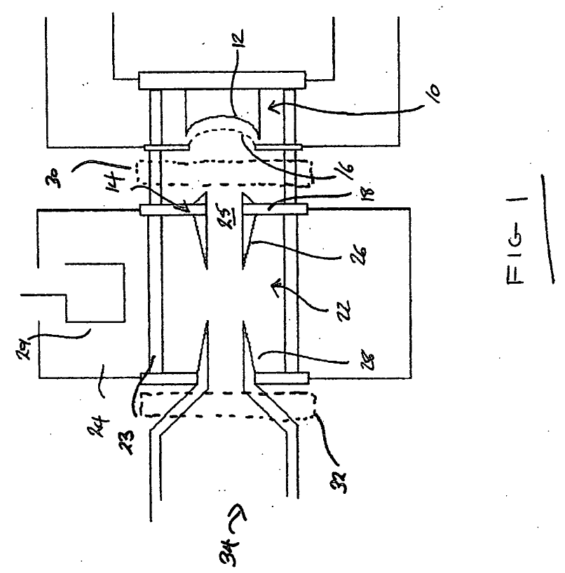

A known external cavity IOT is first described, shown in FIG. 1, which comprises an electron gun 10 for generating an electron beam. The electron beam is created from a heated cathode 12 held at a negative beam potential of around −36 kV and accelerated towards and through an aperture in a grounded anode 14 formed as part of a first portion of a drift tube, (or interaction region), 22 described later. In normal use, the electron gun 10 is uppermost.

A grid 16 is located close to and in front of the cathode and has a DC bias voltage of around −80 volts relative to the cathode potential applied so that, with no RF drive a current of around 500 mA flows. The grid itself is clamped in place in front of the cathode (supported on a metal cylinder) and isolated from the cathode by a ceramic insulator, which also forms part of the vacuum envelope. The RF input signal is provided on an input transmission line between the cathode and grid. The electron gun 10 is coupled to a drift tube 22 and output cavity 24 by a metallic pole piece 18.

The electron beam generated by the electron gun 10, is density modulated by the RF input signal between cathode 12 and grid 16, and is accelerated by the high voltage difference (of the order 30 kV) between the cathode 12 and anode 14 and accelerates into a drift tube/interaction region 22. The drift tube 22 is defined by a first (input) drift tube portion 26 and a second (output) drift tube portion 28 surrounded by an RF cavity 24 containing a wall 23 forming part of the vacuum enclosure with the electron gun and collector assembly. The electron beam passes through a central aperture 25 in the first drift tube portion 26 having a generally disc shaped portion attached to or forming the pole piece 18 and frustoconical section. The whole drift tube 22 is located within a focussing magnetic field created by an upper coil 30 and lower coil 32 shown in dashed line. This creates a magnetic field along the length of the drift tube. The drift tube is typically of copper. Connected to the drift tube section 22 is an output stage including output cavity 24 containing an output coupler in the form of an output loop 29 via which RF energy in the drift tube section 22 couples and is taken from the IOT. This type of output cavity is an external output in the sense that the cavity 24 does not form part of the vacuum envelope within the drift tube 22.

The electron beam having passed through the drift space and output region 20 still has considerable energy, the full beam voltage being typically 30 kV below ground. It is the purpose of the collector stage 34 to collect this energy.

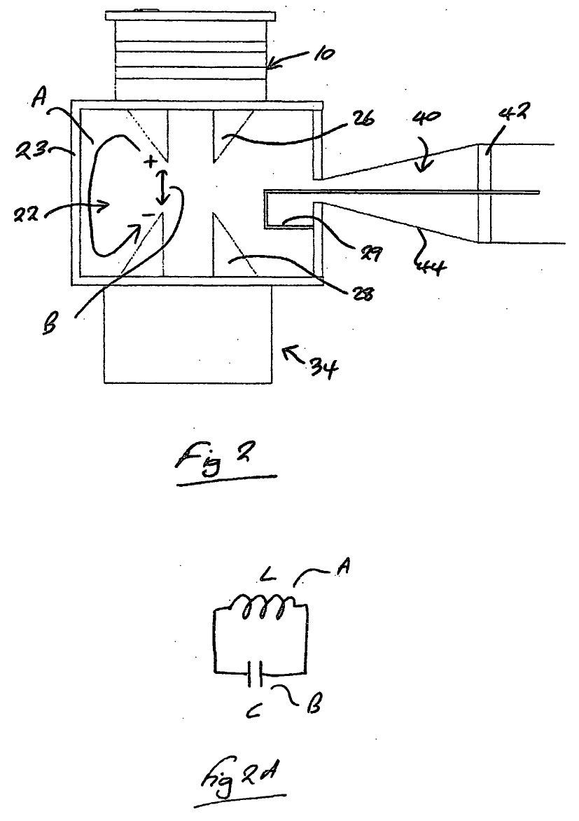

The output arrangement shown in FIG. 1 is an external output cavity 24. An alternative cavity arrangement, such as for use with the present invention, is an integral output cavity shown in FIG. 2. In this arrangement, an electron gun and collector 34 are arranged as before, but now the interaction region comprises the drift tube 22 with an integral output cavity the vacuum of which extends into fixed sidearm 44. The vacuum envelope is defined by cavity wall 23 and sidearm wall 44. The output coupling loop 29 extends into the drift tube cavity 22. The output cavity is thus integral with the vacuum envelope. In such arrangements it is usual for the sidearm 44 to be non-removably fixed to the outer wall 23 of the drift tube cavity. The vacuum envelope is closed by a ceramic disc 42.

The resonant frequency of the integral output cavity is determined by the cavity dimensions. This can be understood by considering the circulation of current around the cavity which has a given inductance L and the transfer of charge across the drift tube gap having a capacitance C. The inductance of the cavity is determined, (to a first order), by the path length around the cavity shown by arrow A. The capacitance is determined, (to a first order), by the drift tube gap shown by arrow B. At a given point in time there will be current flowing around the cavity and a potential difference across the drift tube gap. The frequency of the cavity is given by the standard equation:

$$F = \frac{1}{2 Π \sqrt{LC}}$$

The equivalent circuit of the cavity is shown in FIG. 2A.

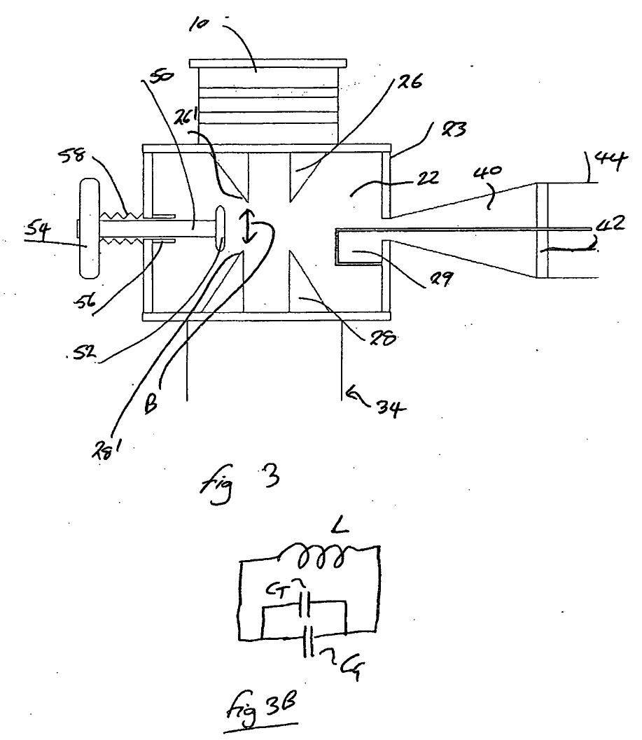

In the external cavity IOT of FIG. 1 it is known to vary the operating frequency by moving an outer wall of the output cavity 24 thereby changing the inductance L of the output cavity. However, we appreciated that this approach is not appropriate to applications for scientific use requiring continuous wave power and for that purpose the integral cavity IOT of FIG. 2 is modified in accordance with the invention as shown in the embodiment of FIG. 3.

The embodiment of the invention in FIG. 3 comprises an electron gun 10, and an output stage having an interaction drift tube cavity 22 (an integral output cavity) with integral output loop 29 and an input drift tube 26 and output drift tube 28 as previously described. The earlier description applies equally here and is not repeated. The vacuum envelope is defined by cavity walls 23 and extends into the cavity 40 of output feeder 44 and is sealed by an output window 42, typically of ceramic.

As already explained, with a fixed output cavity, and for certain applications, it is better, we appreciated, to provide a small amount of frequency fine tuning and for that purpose a capacitative tuner in the form of a tuning plunger 50 is provided. The function of the tuning plunger is to vary the capacitance across the gap B between the first and second drift tube portions 26, 28. As explained above, this will vary the resonant frequency of the cavity. The way this is achieved is by varying the amount by which the plunger protrudes into the cavity, and hence how close the capacitative tuner 52 is to the drift tube 26 and the output drift tube 28. The shorter the distance, the higher the capacitance. There will be capacitance between the tuner 52 and the first drift tube 26, and between the tuner 52 and the second drift tube 28. This will be a series sum of capacitance to give and overall contribution to capacitance of C_{T} (C Tuner). This will sum in parallel with the capacitance between the drift tube portions across the gap C_{G} (C gap) to give a total capacitance:
C=C_{T}+C_{G}
The equivalent circuit is then shown in FIG. 3B.

To vary the plunger distance, a tuning control knob 54 can be turned to move the plunger 50 with respect to an internal bush 56. To seal the vacuum envelope a bellows is provided between the control knob 54 and the outer wall 23 of the drift tube cavity 22.

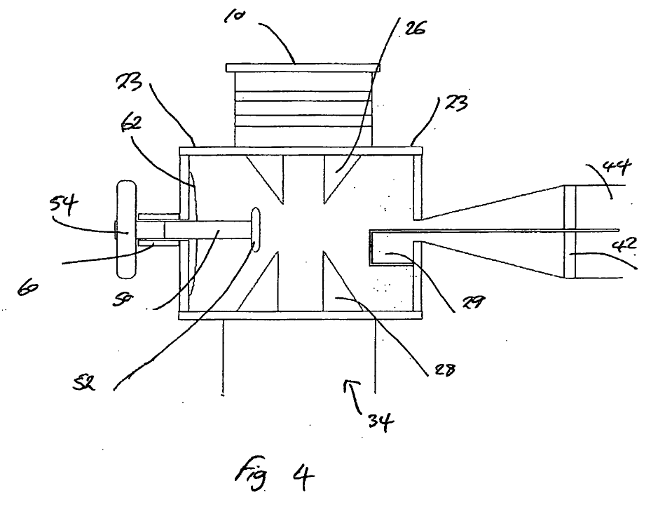

An alternative seal arrangement for the embodiment of the invention is shown in FIG. 4. Like components use the same reference numbers as in FIG. 3 and will not be repeated here. The difference between the two arrangements is the use of a flexible diaphragm seal 62 and external bush 60 in place of the external bellows 58 and internal bush 56 of FIG. 3. The diaphragm is electrically conductive, thereby ensuring RF currents flow across the diaphragm and hence remain within the cavity rather than leaking out of the cavity.

In either of the two alternative seal arrangements, the key point is that the capacitative tuner lies within the vacuum envelope and is controlled from outside the vacuum envelope; hence the need for a seal. The function of the tuner is to provide an additional conductive body, which varies in distance from the drift tube portions to thereby vary the capacitance. The preferred arrangement is a metal disc shaped tuner mounted to a metal rod. However, other shapes and arrangements may serve the function.

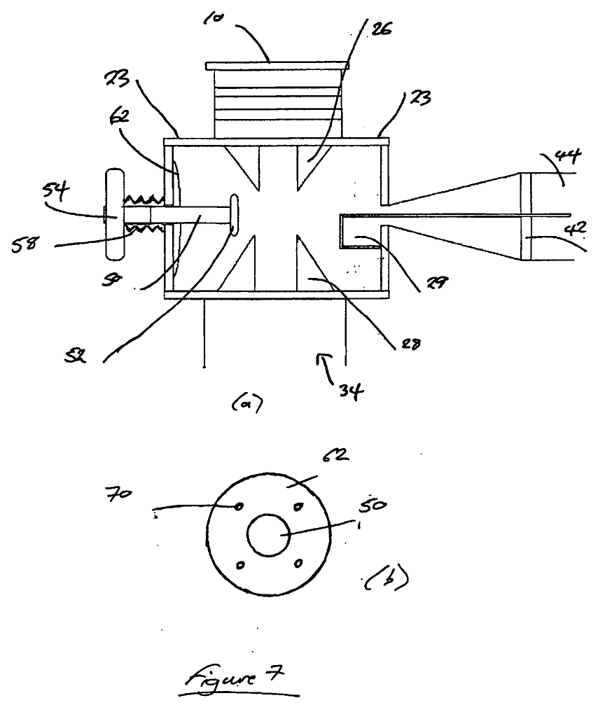

In either the alternatives of FIGS. 3 and 4, we have appreciated the need to reduce any detrimental effects that might be caused by introduction of the additional component (the tuner) into the RF interaction drift tube cavity. One possible problem would be RF leakage around the capacitative to outside the cavity. As already explained, the diaphragm of FIG. 4 is electrically conductive thus allowing it to conduct RF currents within the cavity and prevent RF leakage. We have further appreciated, though, that the functions of sealing the cavity to maintain a vacuum and sealing the cavity against RF leakage could be achieved by a single diaphragm, or by a combination of a conductive diaphragm and a vacuum seal, such as a bellows, as shown in FIG. 7.

The arrangement of FIG. 7a is a hybrid of FIGS. 3 and 4. The external bush 60 of FIG. 4 is replaced by a bellows 58 as in FIG. 3 to seal the vacuum envelope. The flexible diaphragm 62 does not act as a seal as it has four small holes (shown in FIG. 7b) which allow gas to be pumped out of the region between the bellows and the diaphragm. The diameters of the holes are small in order that RF power does not leak from the cavity into the region between the bellows and the diaphragm. In RF terms the diaphragm appears to have no holes. Therefore the RF currents only flow on the internal surface of the diaphragm and not in the region between the bellows and the diaphragm. The advantage of this arrangement is that is ensures the vacuum integrity is maintained even though the tuner moves in and out of the cavity a number of times causing stress to the diaphragm.

A further detrimental effect could be multipactor, which is the effect of electrons being liberated from any of the metal surfaces within the cavity, particularly at a rate higher than incident electrons leading to an avalanche effect.

To reduce the possibility of multipactor, the metal surfaces of the capacitance tuner 52, the input drift tube 26 and output drift tube 28 are coated on their outer surfaces with an anti-multipactor coating. Preferably, titanium or titanium nitride are used.

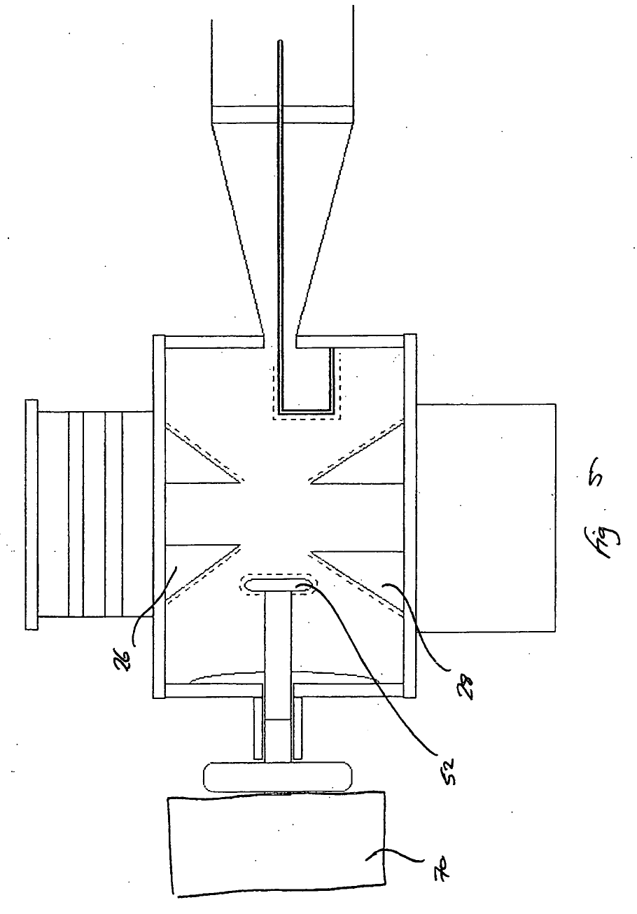

To further enhance usability of the tuning device, a motor, servo or actuator may be coupled to the tuning plunger so as to allow automatic or remote tuning of the IOT. This is particularly useful for high energy applications where the presence of high energy fields or radiation may render access to the IOT hazardous. It is particularly beneficial for scientific applications such as synchrotrons in which many IOTs may be remotely located in a ring of hundreds of metres circumference. A remote servo motor on each such IOT allows remote fine tuning. Such a servo motor 70 is shown in the arrangement of FIG. 5, but this may apply equally to the embodiment shown in FIG. 3, 4 or 7.

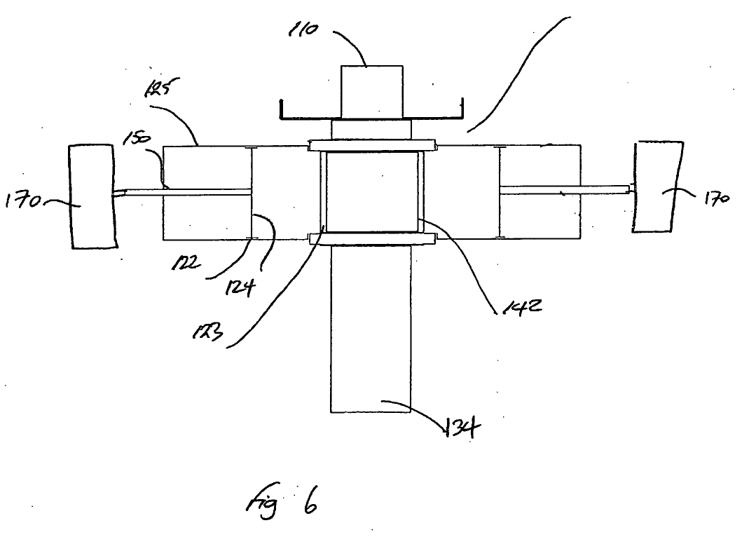

It is noted for completeness that a motor, actuator, servo or similar device may be used with an external cavity IOT and this is shown in FIG. 6, showing how the wall 124 of a cavity may be moved with contact fingers 122 providing contact to an external cavity 125 under control of a motor 170. This type of IOT is an external cavity, rather than integral cavity, with the external cavity not within a vacuum and separated by a ceramic window 142.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. An inductive output tube of the type having an integral output cavity, comprising an input drift tube and an output drift tube arranged within the integral output cavity, an output coupler protruding into the cavity, and further comprising a capacitative tuner within the cavity, the capacitative tuner being moveable inside the cavity so as to vary the distance between the capacitative tuner and the input and output drift tubes so as to vary the capacitance there between, thereby tuning the resonant frequency of the output stage of the inductive output tube.

2. An inductive output tube according to claim 1, wherein the capacitative tuner comprises a metal element mounted on a support.

3. An inductive output tube according to claim 2, wherein the support protrudes through a wall of the cavity.

4. An inductive output tube according to claim 3, wherein the cavity has a vacuum seal between a wall of the cavity and the support in the form of a vacuum bellows.

5. An inductive output tube according to claim 3, wherein the cavity has a vacuum seal between a wall of the cavity and the support in the form of a flexible diaphragm.

6. An inductive output tube according to claim 2, wherein the support is a plunger.

7. An inductive output tube according to claim 1, wherein the capacitative tuner is coated with an anti-multipactor coating.

8. An inductive output tube according to claim 1, wherein the drift tubes are coated with an anti-multipactor coating.

9. An inductive output tube according to claim 1, wherein the capacitative tuner is moveable by action outside the cavity by an actuator.

10. An inductive output tube according to claim 8, wherein the actuator is remotely operable.

11. An inductive output tube according to claim 10, wherein the actuator is a motor.

12. An inductive output tube according to claim 1, wherein the output coupler is an output loop.

13. An inductive output tube according to claim 1, wherein the cavity has a conductive element arranged so as to form an RF seal in relation to the capacitative tuner to prevent RF energy leaving the cavity.

14. An inductive output tube according to claim 13, wherein the RF seal is a conductive diaphragm.

15. An inductive output tube according to claim 13, wherein the RF seal is separate from a vacuum seal.

16. An electron beam tube device, including an inductive output tube, according to claim 1.

17. A synchrotron incorporating a plurality of inductive output tubes, as specified in claim 1.

18. A method of tuning the resonant frequency of an output stage of an inductive output tube comprising moving a capacitative tuner within an integral output cavity of the inductive output tube, so as to vary the distance between the capacitative tuner and the input and output drift tubes, thereby varying the capacitance between the input drift tube and the output drift tube, thereby tuning the resonant frequency of the output stage.
